(19) United States
(12) Patent Application Publication
(10) Pub. No.: US 2017/0082033 A1
(43) Pub. Date: Mar. 23, 2017

(54) GAS TURBINE SYSTEM AND METHOD

(71) Applicants: Wenjie WU, Shanghai (CN); Ping YU, Shanghai (CN); Pradeep Kumar DIDDI, Bangalore, Karnataka (IN); Manuele BIGI, Firenze (IT); David August SNIDER, Greenville, SC (US); Manuel Moises CARDENAS, Greenville, SC (US); GENERAL ELECTRIC COMPANY, Schenectady, NY (US)

(72) Inventors: Wenjie Wu, Shanghai (CN); Ping Yu, Shanghai (CN); Pradeep Kumar Diddi, Bangalore (IN); Manuele Bigi, Calenzano (IT); David August Snider, Simpsonville, SC (US); Manuel Moises Cardenas, Simpsonville, SC (US)

(21) Appl. No.: 14/768,433

(22) PCT Filed: Jun. 10, 2014
(86) PCT No.: PCT/CN2014/079587

§ 371 Date: Aug. 17, 2015

(51) Int. Cl. F02C 9/26; F04D 29/54; F02C 7/36; F01D 21/00; F02C 3/04; F02C 7/22

(52) U.S. Cl. CPC F02C 9/26; F02C 3/04; F02C 7/22; F02C 7/36; F01D 21/003; F04D 29/542; F05D 2220/32; F05D 2240/35; F05D 2260/4023

(57) ABSTRACT

A fuel supply system is provided having a first fuel gas compressor configured to be driven by a motor and a second fuel gas compressor configured to be driven by a shaft of a gas turbine system. The first fuel gas compressor and the second fuel gas compressor are configured to supply a pressurized fuel flow to a combustor of the gas turbine system, and the first fuel gas compressor and the second fuel gas compressor are coupled to one another in series.

### CROSS-REFERENCE TO RELATED APPLICATIONS

This application claims priority from and the benefit of PCT Application No. PCT/CN2014/079587, filed on Jun. 10, 2014, entitled “Gas Turbine System and Method,” which is herein incorporated by reference in its entirety.

### BACKGROUND OF THE INVENTION

The subject matter disclosed herein relates to power generation systems, and, more particularly, to a fuel gas compressor system.

Syngas fuel is widely used for generation power plants with gas turbines systems. For example, the gas turbine system may include one or more combustors, which may combust the fuel to produce hot combustion gases. The resulting hot combustion gases may then be used to drive one or more turbines. Generally, the fuel supplied to the combustor of the gas turbine system is supplied at an elevated pressure. However, it may be difficult to sufficiently pressurize the fuel during startup operation and to operate with high efficiency.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a fuel supply system having a first fuel gas compressor coupled to a compressor shaft and configured to pressurize a fuel for a gas turbine system. The fuel supply system includes a first and second clutches. The first clutch is configured to selectively engage the compressor shaft segment to a motor shaft of a motor. The second clutch is configured to selectively engage the compressor shaft to a turbine shaft of the gas turbine system.

In a second embodiment, a method includes engaging a first clutch to couple a compressor shaft of a first fuel gas compressor to a motor shaft of a motor. The first fuel gas compressor is driven using the motor in order to pressurize a fuel. The first clutch is disengaged to decouple the fuel compressor shaft from the motor shaft. A second clutch is engaged to couple the compressor shaft to a turbine shaft of a gas turbine system. The first fuel gas compressor is driven using a turbine of the gas turbine system to pressurize the fuel.

In a third embodiment, a system includes a controller configured to control compression of a fuel for a gas turbine system, wherein the controller is configured to selectively engage a first clutch or a second clutch to drive a fuel gas compressor using a respective motor shaft or turbine shaft.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a gas turbine system having a fuel supply system with features to improve the operability of the gas turbine system;

FIG. 2 is a schematic diagram of an embodiment of the fuel supply system of FIG. 1 having two fuel gas compressors in series and two clutches to selectively engage one of the fuel gas compressors to a motor;

FIG. 3 is a schematic diagram of an embodiment of the fuel supply system of FIG. 2, illustrating the clutches in a position to drive the first fuel gas compressor using the motor and the second fuel gas compressor using a turbine shaft;

FIG. 4 is a schematic diagram of an embodiment of the fuel supply system of FIG. 2, illustrating the clutches transitioning between first and second positions;

FIG. 5 is a schematic diagram of an embodiment of the fuel supply system of FIG. 2, illustrating the clutches in a position to drive both fuel gas compressors using a turbine shaft;

FIG. 6 is a schematic diagram of an embodiment of the fuel supply system of FIG. 1 having three fuel gas compressors in series and a plurality of clutches to selectively engage one or more of the fuel gas compressors to a motor; and

FIG. 7 is a schematic diagram of an embodiment of the fuel supply system of FIG. 1 having a plurality of fuel gas compressors and a single clutch to selectively engage one or more of the fuel gas compressors to a motor.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems and methods to pressurize a fuel for a gas turbine system. During normal operation, certain gas turbines combust a mixture of oxidant (e.g., air, oxygen, or oxygen-enriched air) and fuel gas (i.e., vapor-phase fuel) into combustion products. The combustion products force blades of a turbine to rotate, thereby driving a turbine shaft into rotation. The rotating turbine shaft drives certain components of the gas turbine system, such as one or more fuel gas compressors that pressurize the fuel gas for the gas turbine. During normal operation, the rotating speed of the turbine shaft enables to the fuel gas compressors to sufficiently pressurize the fuel gas for delivery to the gas turbine. However, during start-up of the gas turbine, the rotating speed of the turbine shaft may be too low to adequately compress the fuel gas. In certain embodiments, liquid fuels are routed to the gas turbine during initial stages of the startup process, and fuel gases are introduced once the speed of the turbine shaft is sufficient. Unfortunately, liquid fuel-based startups may be difficult and relatively expensive.

In order to use fuel gas throughout the startup process, a motor (e.g., an electric motor) may be used to drive the fuel gas compressor when the rotating speed of the turbine shaft is low. Once the speed of the turbine shaft is sufficiently high to pressurize the fuel gas, the fuel gas compressor may be driven by the turbine shaft. To this end, a clutch is disposed along the turbine shaft in order to selectively couple the fuel gas compressor to the motor or to the turbine shaft.

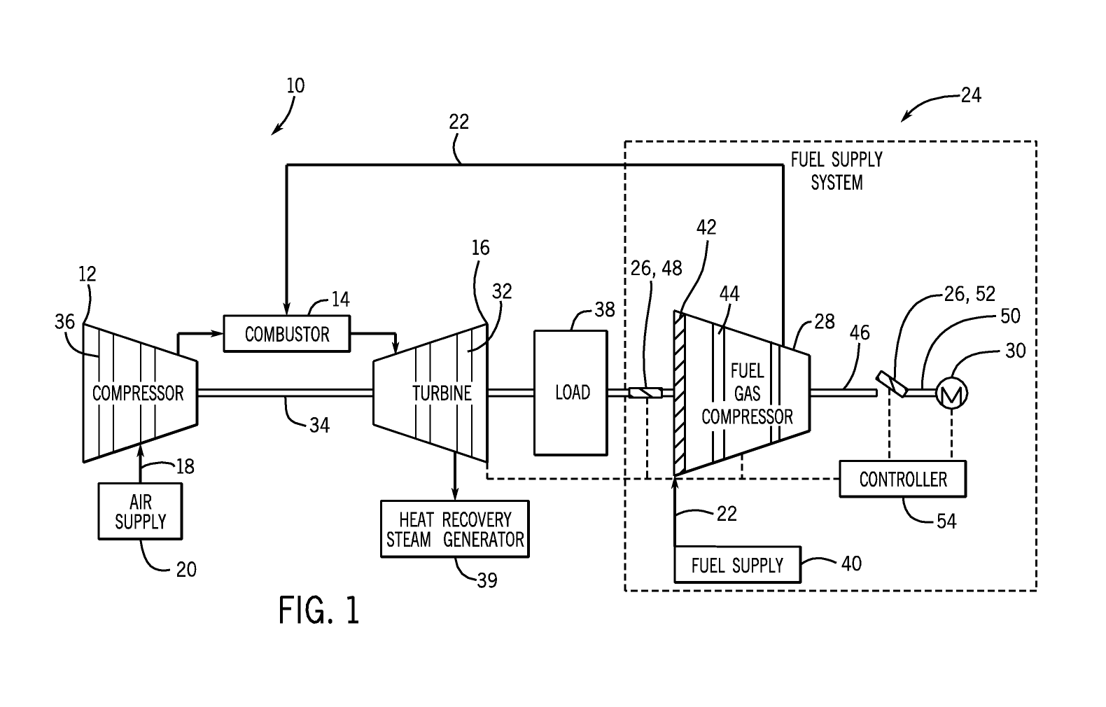

Turning now to the figures, FIG. 1 is a schematic diagram of an embodiment of a gas turbine system 10. The gas turbine system 10 includes a compressor 12, a combustor 14, and a turbine 16. The embodiments of the gas turbine system 10 may be configured to operate with a variety of oxidants 18, such as air, oxygen, or oxygen-enriched air. However, for purposes of discussion, the system 10 is described with air as the oxidant 18. The compressor 12 receives the air 18 from an air supply 20 and compresses the air 18 for delivery into the combustor 14. The combustor receives the air 18 and pressurized fuel 22 from a fuel supply system 24. As described in greater detail below, the fuel supply system 24 includes one or more clutches 26 to enable a fuel gas compressor 28 to be selectively driven by either the turbine 16 or a motor 30 (e.g., an electric motor, combustion engine, or other drive).

The combustor 14 ignites a mixture of the air 18 and the fuel 22 into hot combustion gases. These combustion gases flow into the turbine 16 and force turbine blades 32 to rotate, thereby driving a shaft 34 (e.g., turbine shaft) into rotation. The rotation of the shaft 34 provides energy for the compressor 12 to pressurize the air 18. More specifically, the shaft 34 rotates compressor blades 36 attached to the shaft 34 within the compressor 12, thereby pressurizing the air 18. In addition, the rotating shaft 34 may rotate or drive a load 38, such as an electrical generator or any device capable of utilizing the mechanical energy of the shaft 34. After the turbine 16 extracts useful work from the combustion products, the combustion products are routed to a heat recovery steam generator (HRSG) 39. The HRSG 39 may, for example, recover waste heat from the combustion products to produce steam, which may be further used to drive a steam turbine.

During normal operation (e.g., steady-state or full-load operation) of the gas turbine system 10, the rotating shaft 34 may also be used to drive the fuel gas compressor 28. For example, the fuel gas compressor 28 receives the fuel 22 from a fuel supply 40, as illustrated. The fuel 22 may enter the fuel gas compressor 28 through a plurality of inlet guide vanes (IGVs) 42, which may be used to control a flow rate of the fuel 22. More specifically, the pitch of the IGVs 42 may be varied, thereby throttling the inlet flow of the fuel 22 into the fuel gas compressor 28. Within the fuel gas compressor 28, the rotation of compressor blades 44 coupled to a compressor shaft 46 pressurizes the fuel 22 for delivery to the combustor 14.

During normal operation (e.g., steady-state operation), the compressor shaft 46 may be coupled to and driven by the turbine shaft 34 via a clutch 48. Thus, the clutch 48 enables a transfer of power from the turbine 16 to the fuel gas compressor 28 (e.g., from the turbine shaft 34 to the compressor shaft 46). As will be appreciated, the clutch 48 may be disengaged during certain operating periods when it may be advantageous to drive the compressor shaft 46 with power from other sources. For example, during start-up or transient periods of operation, the speed of the rotating shaft 34 may be insufficient to drive the compressor shaft 46 of the fuel gas compressor 28. Sufficient power (e.g., rotational motion) may be provided by a motor shaft 50 of the motor 30. Because the operation of the motor 30 is independent of the operation of the gas turbine system 10, the motor 30 may be used to drive the fuel gas compressor 28 when the gas turbine system 10 is in a transient or start-up state. As shown, the compressor shaft 46 may be coupled to and driven by the motor shaft 50 via a clutch 52. In certain embodiments, the compressor shaft 46, the motor shaft 50, and the turbine shaft 34 may be coaxial.

A controller 54 is communicatively coupled to the turbine 16, the fuel gas compressor 28, the inlet guide vanes 42, the motor 30, and the clutches 48 and 52. As described further below, the controller 54 executes instructions in order to engage or disengage each clutch 48 and 52 based on the operating mode of the gas turbine system 10. For example, a low speed of the turbine shaft 34 may be indicative of a start-up mode. The controller 54 may execute instructions to drive the fuel gas compressor 28 using the motor 30 by, for example, disengaging the clutch 48 and engaging the clutch 52 to couple the compressor shaft 46 to the motor shaft 50.

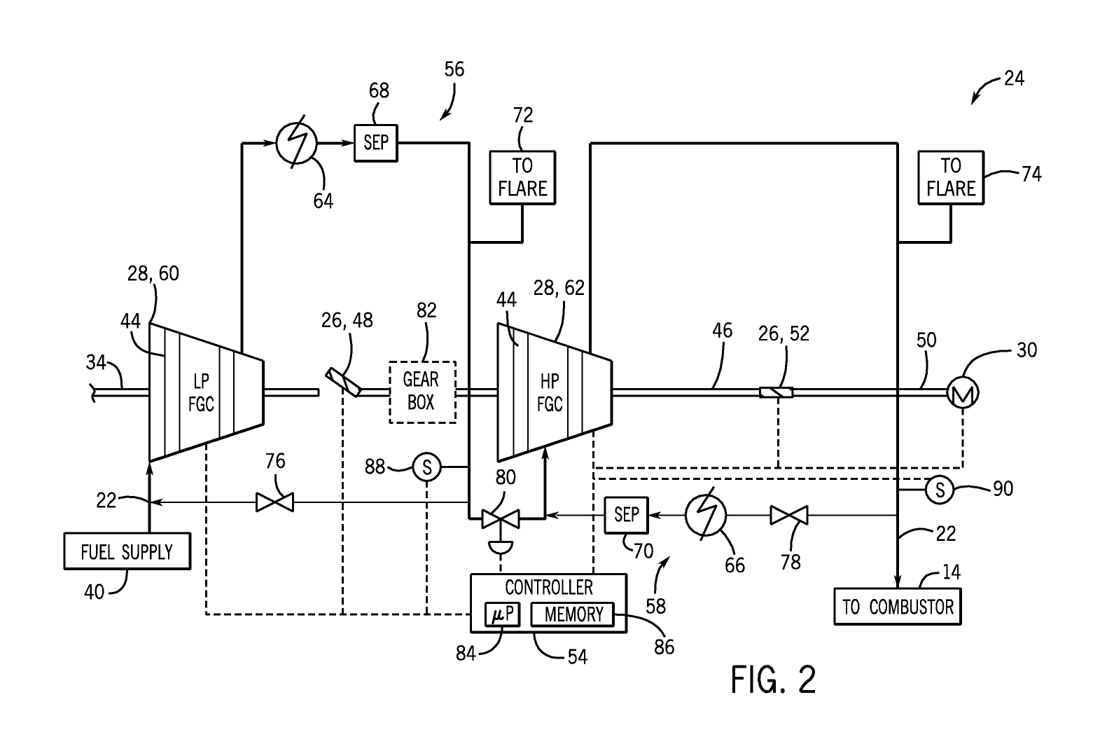

It should be noted that the fuel supply system 24 may include multiple fuel gas compressors. For example, the fuel 22 may be compressed to an intermediate pressure by a first compressor and subsequently compressed to a higher pressure using a second fuel gas compressor. Multiple stages of compression may increase the pressure of the fuel 22 as well as the efficiency of the fuel supply system 24. Thus, certain embodiments of the fuel supply system 24 may include 1, 2, 3, 4, or more fuel gas compressors 28 with associated compressor shafts and clutches, as will be discussed further below with respect to FIG. 2.

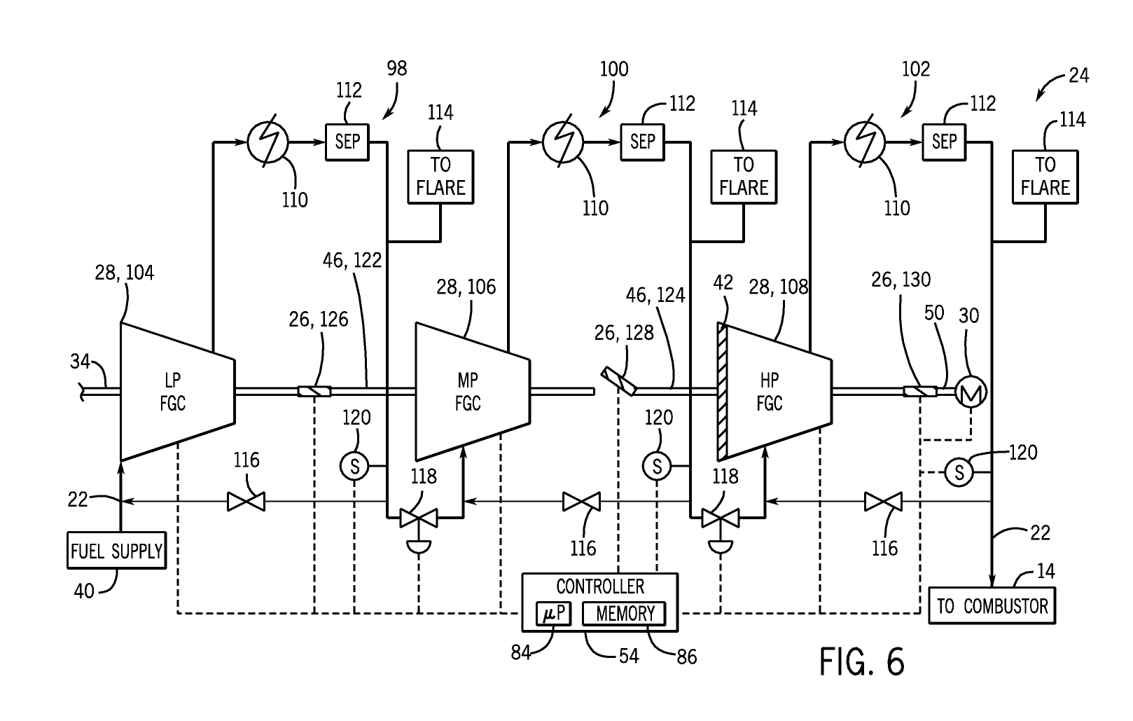

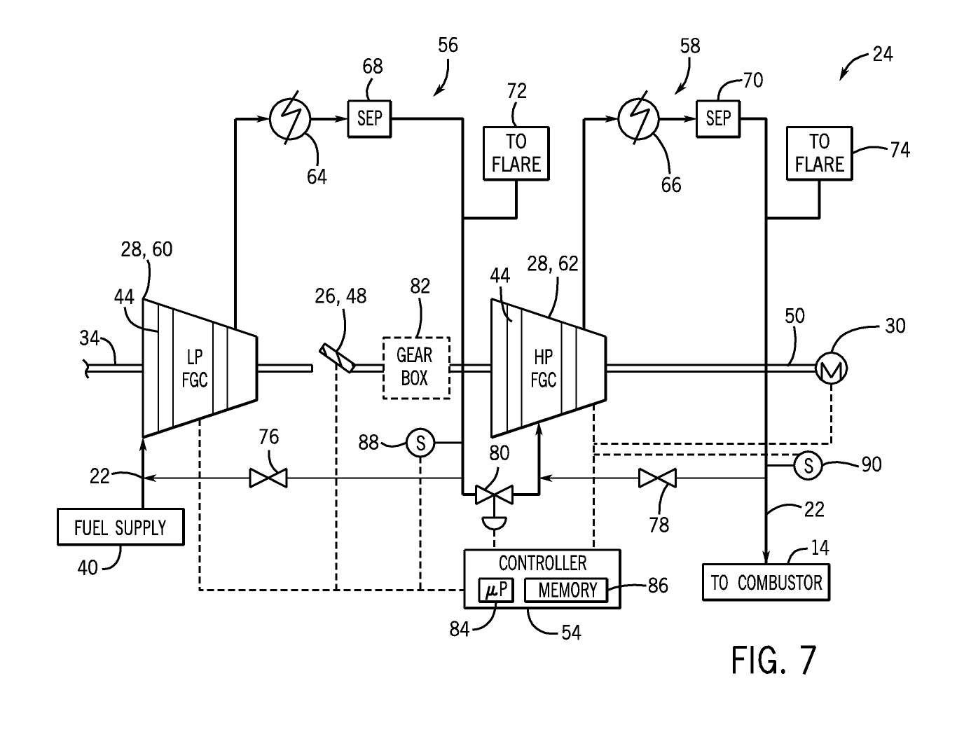

FIG. 2 illustrates an embodiment of the fuel supply system 24 having two stages of compression 56 and 58. More specifically, the fuel 22 from the fuel supply 40 is compressed by a low pressure fuel gas compressor 60 (e.g., 28) and then is further compressed by a high pressure fuel gas compressor 62 (e.g., 28). After each stage of compression 56 and 58, the fuel 22 is cooled within respective coolers 64 and 66. As will be appreciated, certain fuels 22 may include one or more condensable components (e.g., steam, hydrocarbons, sulfides). When the fuel 22 is cooled, these components may condense into a liquid form. Accordingly, separators 68 and 70 are disposed along the fuel flow path in each stage of compression 56 and 58 in order to separate the liquid condensate from the remaining vapor fuel 22. It should be noted that the coolers 64 and 66 as well as the separators 68 and 70 may occupy various positions within the fuel supply system 24. For example, the cooler 66 and the separator 70 may be upstream of a spillback valve 78, as shown in FIGS. 6 and 7.

Turning back now to FIG. 2, flares 72 and 74 are also disposed along the flow path in each stage of compression 56 and 58 of the fuel 22. The flares 72 and 74 enable pressure control of the fuel supply system 24 by, for example, venting a portion of the fuel 22 when the pressure is too high. The pressure of the fuel supply system 24 may also be controlled by spillback valves 76 and 78. More specifically, opening the spillback valves 76 or 78 enables a portion of the compressor discharge to flow back to the compressor inlet, thereby increasing the discharge pressure of the respective compressors 60 and 62. In addition, certain compressors may start-up in a full spillback mode, wherein the entirety of the compressor discharge is circulated back to the compressor inlet.

A control valve 80 is disposed between the compressors 60 and 62. Depending on the operating mode of the combustor 14, it may be desirable to increase or decrease the flow of the fuel 22. For example, during start-up operation, the flow of fuel 22 is gradually increased as the gas turbine system 10 starts up. During turndown operation, the flow of the fuel 22 may be gradually decreased. Even during normal operation, the flow rate of the fuel 22 may be adjusted slightly in order to maintain stable operating conditions within the combustor 14. Thus, the control valve 80 may be throttled as desired in order to adjust the flow rate of the fuel 22. In certain embodiments, the control valve 80 may be adjusted by the controller 54.

As discussed above, the fuel supply system 24 includes one or more clutches 26 that enable the compressors 60 and 62 to be driven by the motor 30 or the turbine 16 (shown in FIG. 1). In the embodiment shown, the low pressure (LP) compressor 60 is coupled to the turbine shaft 34, whereas the high pressure (HP) compressor 62 is coupled to the separate compressor shaft 46. The LP compressor 60 is continuously driven by the turbine shaft 34. However, the HP compressor 62 is driven by the compressor shaft 46, which in turn may be driven by either the turbine shaft 34 or the motor shaft 50. It should be noted that in alternative embodiments, the LP compressor 60 may also include a separate shaft that is selectively driven by either the turbine shaft 34 or the motor shaft 50.

A gearbox 82 is coupled to the compressor shaft 46. The gearbox 82 includes one or more gears and/or gear trains that enable the compressor shaft 46, the turbine shaft 34, and the motor shaft 50 to rotate at different speeds. Depending on the design of the gearbox 82, a ratio of shaft speeds between the driving shaft (e.g., the turbine shaft 34 or the motor shaft 50) and the driven shaft (e.g., the compressor shaft 46) may be between approximately 10:1 to 1:10, 5:1 to 1:5, 2:1 to 1:2, and all subranges therebetween. In addition, the gear ratio may be selected based on the operating condition of the gas turbine system 10. For example, a lower gear ratio may be desirable during normal operation, in order to improve the efficiency of the fuel supply system 24. However, a higher gear ratio may be more efficient during startup, when the speeds of the shafts 34, 46, and 50 are generally lower. Certain embodiments of the fuel supply system 24 may not include the gearbox 82, whereas others may include 1, 2, 3, 4, or more gearboxes 82.

As noted earlier, the controller 54 controls the position of the clutches 48 and 52, which determines whether the compressor shaft 46 is driven by the turbine shaft 34 or the motor shaft 50. To this end, the controller 54 includes a processor 84 and memory 86 to execute instructions to control the clutches 48 and 52. These instructions may be encoded in software programs that may be executed by the processor 84. Further, the instructions may be stored in a tangible, non-transitory, computer-readable medium, such as the memory 86. The memory 86 may include, for example, random-access memory, read-only memory, hard drives, and the like.

The controller 54 is communicatively coupled to each of the compressors 60 and 62, the clutches 48 and 52, the control valve 80, and sensors 88 and 90. The sensors 88 and 90 detect one or more operating conditions associated with the respective stages of compression 56 and 58. For example, the sensors 88 and 90 may detect a flow rate of the fuel 22, a pressure of the fuel 22, a temperature of the fuel 22, a compressor speed, vibration, and the like. The controller 54 may adjust the position of the clutches 48 and 52 based on the operating conditions detected by the sensors 88 and 90.

In one embodiment, the sensors 88 and 90 detect compressor speeds of the respective compressors 60 and 62 as indications of the operating mode of the gas turbine system 10. For example, when the speed of the turbine shaft 34 is less than a threshold (e.g., approximately 60, 50, or 40 percent of the rated speed), the controller 54 may determine that the gas turbine system 10 is in a start-up or turndown mode. In such circumstances, it may be efficient to drive the HP compressor 62 using the motor 30 rather than the turbine shaft 34. Accordingly, the controller 54 disengages the clutch 48 and engages the clutch 52. As a result, the LP compressor 60 is coupled to and driven by the turbine shaft 34, whereas the HP compressor 62 is coupled to and driven by the motor shaft 50. This configuration enables the fuel 22 to be adequately pressurized for delivery to the combustor 14, even though the speed of the turbine shaft 34 is relatively low.

When the speed of the turbine shaft 34 increases above a threshold (e.g., approximately 40, 50, or 60 percent of the rated speed), it may be more efficient to drive the compressor shaft 46 using the turbine shaft 34 rather than the motor shaft 50. To this end, the controller 54 engages the clutch 48 and disengages the clutch 52. As a result, both of the compressors 60 and 62 are coupled to and driven by the turbine shaft 34. In certain embodiments, the threshold compressor speeds may be different. For example, the controller 54 may engage or disengage the clutches 48 and 52 when the speed of the turbine shaft is between approximately 10 to 90, 20 to 80, or 30 to 70 percent of the rated speed. Additionally or alternatively, the controller 54 may control the clutches 48 and 52 based on other operating conditions, such as pressures, flows, temperatures, and the like. For example, in response to an alarm setpoint, the controller 54 may disengage both clutches 48 and 52 to decrease the flow rate of the fuel 22 to the combustor 14.

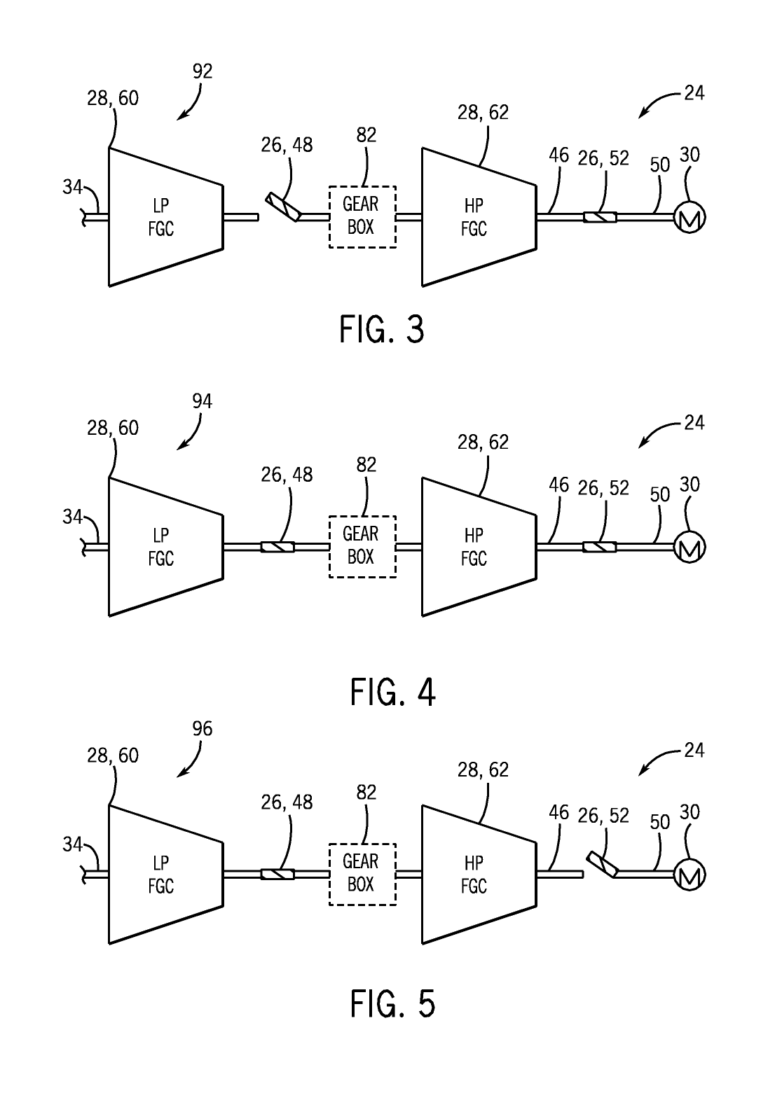

FIGS. 3-5 illustrate various positions of the clutches 48 and 52 of the fuel supply system 24. For example, the position of the clutches 48 and 52 may begin in a first configuration 92 (FIG. 3) and may transition through a second configuration 94 (FIG. 4) to a third configuration 96 (FIG. 5). In certain embodiments, the first configuration 92 may be indicative of a start-up mode of the gas turbine system 10, whereas the third configuration 96 may be indicative of a steady-state or normal operation. It should be noted that the order of the configurations 92, 94, and 96 is interchangeable and may depend on the operating conditions of the gas turbine system 10.

FIG. 3 illustrates the configuration 92 of the clutches 48 and 52 to enable the motor 30 to drive the HP compressor 62. As shown, the clutch 48 is disengaged from the turbine shaft 34, whereas the clutch 52 is engaged to the motor shaft 50. The illustrated configuration 92 may be desirable, for example, when the speed of the turbine shaft 34 is relatively low, and the motor 30 is able to provide greater rotation of the compressor shaft 46 (e.g., during start-up of the gas turbine system 10).

FIG. 4 illustrates another configuration 94 of the clutches 48 and 52 that enables a smooth transition between the configurations of FIG. 3 and FIG. 5. As will be appreciated, when the compressors 60 and 62 are driven by different shafts (e.g., the turbine shaft 34 and the motor shaft 50, respectively), the compressors 60 and 62 may rotate with different speeds or with different amounts of torque. Accordingly, it may be desirable to equilibrate the various shaft speeds and/or torques to enable a smooth transition between the configurations of FIG. 3 and FIG. 5. As shown, when each of the clutches 48 and 52 is engaged, the various shafts 34, 46, and 50 are coupled together and may behave as a single shaft, thereby resulting in a more stabilized shaft speed.

As noted earlier, the gearbox 82 enables the various shafts 34, 46, and 50 to rotate with different speeds. Accordingly, when the clutches 48 and 52 are engaged, the shafts 34, 46, and 50 may continue to rotate at different speeds. However, in certain embodiments, it may be desirable for the various shafts 34, 46, and 50 to rotate with an approximately uniform speed when transitioning between the configurations of FIG. 3 and FIG. 5. A uniform shaft speed may be enabled by, for example, employing an approximately 1:1 gear ratio using the gearbox 82.

FIG. 5 illustrates the configuration 96 of the clutches 48 and 52 that enables the turbine shaft 34 to drive both of the compressors 60 and 62. As shown, the clutch 48 is engaged to the turbine shaft 34, whereas the clutch 52 is disengaged from the motor shaft 50. The illustrated configuration 96 may be desirable during steady-state or normal operation of the gas turbine system 10, when the turbine shaft 34 is able to provide greater rotation of the compressor shaft 46.

FIG. 6 illustrates an embodiment of the fuel supply system 24 having three stages of compression 98, 100 and 102. More specifically, the fuel 22 is compressed by three compressors that are fluidly connected in series: an LP compressor 104, a medium pressure (MP) compressor 106, and an HP compressor 108. As shown, the HP compressor includes the IGVs 42, whereas the LP and MP compressors 104 and 106 do not. However, in other embodiments, any or all of the fuel gas compressors 28 may include the IGVs 42.

The fuel supply system 24 includes coolers 110, separators 112, flares 114, spillback valves 116, control valves 118, and sensors 120, each having similar functionality to the respective components of FIG. 2. As shown, the MP and HP compressors 106 and 108 have separate compressor shafts 122 and 124. Clutches 126, 128, and 130 are coupled between the shafts 34, 122, 124, and 50 to enable the turbine 16 (shown in FIG. 1) or the motor 30 to drive the shafts 34, 50, 122, and 124. For example, in the configuration illustrated, the clutches 126 and 130 are engaged, whereas the clutch 128 is disengaged. Accordingly, the LP and MP compressors 104 and 106 are driven by the turbine shaft 34, whereas the HP compressor 108 is driven by the motor shaft 50. As noted earlier, this configuration may be desirable when the gas turbine system 10 is operating in a start-up mode. During normal operation, the clutches 126 and 128 may be engaged, while the clutch 130 is disengaged. Accordingly, the turbine shaft 34 may drive all of the fuel gas compressors 104, 106, and 108, while the motor 30 is decoupled from the turbine shaft 34. It should be appreciated that other numbers of fuel gas compressors 28 and clutches 26 are contemplated and fall within the scope and spirit of the present disclosure.

FIG. 7 illustrates an embodiment of the fuel supply system 24 having the clutch 26, 48 to improve the operability of the gas turbine system 10. The embodiment shown in FIG. 7 is similar to the embodiment illustrated in FIG. 2, except for the clutch 26, 52. Removal of the clutch 26, 52 may generally reduce the cost of the gas turbine system 10. During start-up operation, the clutch 26, 48 may be disengaged. Accordingly, the HP compressor 62 is driven by the motor shaft 50, and the LP compressor 60 is driven by the turbine shaft 34. When the clutch is engaged, the turbine shaft 34 drives both the HP compressor 62 and the LP compressor 60, and the motor 30 remains coupled to the turbine shaft 34. In such a configuration, the motor 30 may run idle when coupled to the turbine shaft 34 to improve the efficiency of the gas turbine system 10.

Technical effects of the disclosed embodiments include fuel supply systems 24 with one or more clutches 26 that improve the operability of the gas turbine system 10. In particular, the clutches 26 enable the fuel gas compressors 28 to be driven by either the turbine 16 or the motor 30, depending on which is desired at a given time or stage of operation. Accordingly, when the speed of the turbine shaft 34 is low, such as during start-up operation of the gas turbine system 10, the clutch 26 may be engaged or disengaged to drive the fuel gas compressor 28 using the motor 30. When the speed of the turbine shaft 34 is sufficiently high, the clutch may be engaged or disengaged to drive the fuel gas compressor 28 using the turbine 16.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a fuel supply system, comprising:
a first fuel gas compressor coupled to a compressor shaft and configured to pressurize a fuel for a gas turbine system;
a first clutch configured to selectively engage the compressor shaft with a motor shaft of a motor; and
a second clutch configured to selectively engage the compressor shaft with a turbine shaft of the gas turbine system.

2. The system of claim 1, wherein the first fuel gas compressor comprises a plurality of inlet guide vanes.

3. The system of claim 2, comprising a gearbox coupled to the compressor shaft.

4. The system of claim 1, comprising the gas turbine system, wherein the gas turbine system comprises:
a compressor configured to pressurize an oxidant;
a combustor configured to combust the oxidant supplied by the compressor and the fuel supplied by the first fuel gas compressor into combustion products; and
a turbine coupled to the turbine shaft and configured to extract work from the combustion products to rotate the turbine shaft.

5. The system of claim 4, comprising the motor coupled to the motor shaft.

6. The system of claim 4, wherein the fuel supply system comprises a second fuel gas compressor coupled to the turbine shaft of the gas turbine system and configured to pressurize the fuel.

7. The system of claim 6, wherein the fuel supply system comprises a fuel flow path, the first and second fuel gas compressors are disposed along the fuel flow path, and the second fuel gas compressor is disposed upstream of the first fuel gas compressor.

8. The system of claim 4, wherein the fuel supply system comprises:
a sensor configured to measure an operating parameter of the gas turbine system; and
a controller configured to regulate operation of the first and second clutches based on the measured operating parameter.

9. A method, comprising:
engaging a first clutch to couple a compressor shaft of a first fuel gas compressor to a motor shaft of a motor;
driving the first fuel gas compressor using the motor to pressurize a fuel;
disengaging the first clutch to decouple the compressor shaft from the motor shaft;
engaging a second clutch to couple the compressor shaft to a turbine shaft of a turbine of a gas turbine system; and
driving the first fuel gas compressor using the turbine to pressurize the fuel.

10. The method of claim 9, comprising:
detecting an operating parameter related to compression of the fuel;
comparing the operating parameter to a threshold;
engaging the first clutch to drive the fuel gas compressor using the motor when the operating parameter is within a first range based on the threshold; and
engaging the second clutch to drive the fuel gas compressor using the turbine shaft when the operating parameter is within a second range based on the threshold.

11. The method of claim 10, wherein the operating parameter comprises a pressure of the fuel, a flow rate of the fuel, a speed of the turbine shaft, a speed of the motor shaft, or any combination thereof.

12. The method of claim 9, comprising driving a second fuel gas compressor using the turbine shaft to pressurize the fuel, wherein the second fuel gas compressor is serially connected to the first fuel gas compressor.

13. The method of claim 12, wherein the first and second fuel gas compressors sequentially pressurize the fuel.

14. The method of claim 12, comprising driving the first and second fuel gas compressors at different speeds using a gearbox.

15. The method of claim 14, comprising selecting a gear ratio of the gearbox based on an operating mode of the gas turbine system.

16. A system, comprising:
a controller configured to control compression of a fuel for a gas turbine system, wherein the controller is configured to selectively engage a first clutch or a second clutch of a fuel supply system to drive a fuel gas compressor of the fuel supply system using a respective motor shaft or turbine shaft.

17. The system of claim 16, wherein the controller is configured to engage the first clutch to drive the fuel gas compressor using a motor coupled to the motor shaft when the gas turbine system is in a start-up mode.

18. The system of claim 17, wherein the controller is configured to disengage the first clutch and to engage the second clutch to drive the fuel gas compressor using a turbine coupled to the turbine shaft when the gas turbine system is not in a start-up mode.

19. The system of claim 18, wherein the controller is configured to determine when the gas turbine system is in the start-up mode by comparing a measured operating parameter to a threshold.

20. The system of claim 18, wherein the operating parameter comprises a flow rate of the fuel, a speed of the turbine shaft, or both.
